(19) United States
(12) Patent Application Publication
(10) Pub. No.: US 2005/0117046 A1
(43) Pub. Date: Jun. 2, 2005

(54) Image sensor module and method for manufacturing the same

(76) Inventor: Jichen Wu, Hsinchu Hsien (TW)

Correspondence Address: Keith Kline;PRO-TECHTOR INTERNATIONAL SERVICES, 20775 Norada Court, Saratoga, CA, 95070-3018, US

(21) Appl. No.: 10/726,865

(22) Filed: Dec. 2, 2003

(51) Int. Cl. H04N 5/225; G02B 13/16

(52) U.S. Cl. 348/335; 348/374

(57) ABSTRACT

An image sensor module includes an image sensor package formed with a top end face having a transparent layer and a bottom end face. A lens holder is formed with a chamber, which has an internal thread formed at the inner wall, so that the transparent layer of the image sensor package is arranged at the lens holder. A lens barrel is inserted within the chamber of the lens holder, and is formed with an external thread, which is screwed on the internal thread of the lens holder. The lens barrel is formed with an opening and a hole communicating the opening, which is formed with a first positioned slot for positioning an aspheric lens.

### BACKGROUND OF THE INVENTION

1. Field of the Invention

The invention relates to an image sensor module and a method for manufacturing the same, and in particular to image sensor module that is easy to be assembled, disassembled and effectively positioned.

2. Description of the Related Art

Referring to FIG. 1, a conventional image sensor module includes a lens holder 10, a lens barrel 20, and an image sensor 30. The lens holder 10 has an upper end face 12, a lower end face 14 and an opening 16 penetrating through the lens holder 10 from the upper end face 12 to the lower end face 14. An internal thread 18 is formed on an inner wall of the opening 16 of the lens holder 10. The lens barrel 20 formed with an external thread 22 is inserted from the upper end face 12 of the lens holder 10, received within the opening 16, and screwed to the internal thread 18 of the lens holder 10. The lens barrel 20 is formed with a transparent region 24 under which an aspheric lens 26 and an infrared filter 28 are arranged in sequence. The image sensor 30 has a substrate 31, which has a first surface 32 and a second surface 33 opposite to the first surface 32 on which a frame layer 36 is arranged. The first surface 32 is formed with first connected point 34. The second surface 33 is formed with second connected point 35. The photosensitive chip 37 is mounted on the first surface 32 of the substrate 31 and electrically connected to the first connected point 34 by wires 38. A transparent layer 39 is adhered to the frame layer 36 for encapsulating the photosensitive vhip 37 and wires 38.

The image sensor 30 is bonded to the lower end face 14 of the lens holder 10 through the transparent layer 39. The screwed length between the lens barrel 20 and the lens holder 10 may be adjusted to control the distance from the aspheric lens 26 of the lens barrel 20 to the transparent layer 39 of the image sensor 30.

The above-mentioned image sensor module has the following drawbacks.

Because the aspheric lens 26 and an infrared filter 28 are bonded within the lens barrel 20, it is complicate to be assembled . And the aspheric lens 26 and an infrared filter 28 are easily damage.

It is an important subject of the invention to provide an image sensor module, which is easy to be assembled, disassembled, and effectively positioned.

### SUMMARY OF THE INVENTION

An object of the invention is to provide an image sensor module for miniaturizing the product equipped therewith.

Still another object of the invention is to provide an image sensor module capable of precisely positioning so as to facilitate the manufacturing processes.

To achieve the above-mentioned objects, the invention provides an image sensor module includes an image sensor package formed with a top end face having a transparent layer and a bottom end face. A lens holder is formed with a chamber, which has an internal thread formed at the inner wall, so that the transparent layer of the image sensor package is arranged at the lens holder. A lens barrel is inserted within the chamber of the lens holder, and is formed with an external thread, which is screwed on the internal thread of the lens holder. The lens barrel is formed with an opening and a hole communicating the opening, which is formed with a first positioned slot for positioning an aspheric lens.

### BRIEF DESCRIPTION OF THE DRAWINGS

FIG. 1 is a schematic illustration showing a conventional image sensor module.

FIG. 2 is a first schematic illustration showing an image sensor module of the invention.

FIG. 3 is a second schematic illustration showing the image sensor module of the invention.

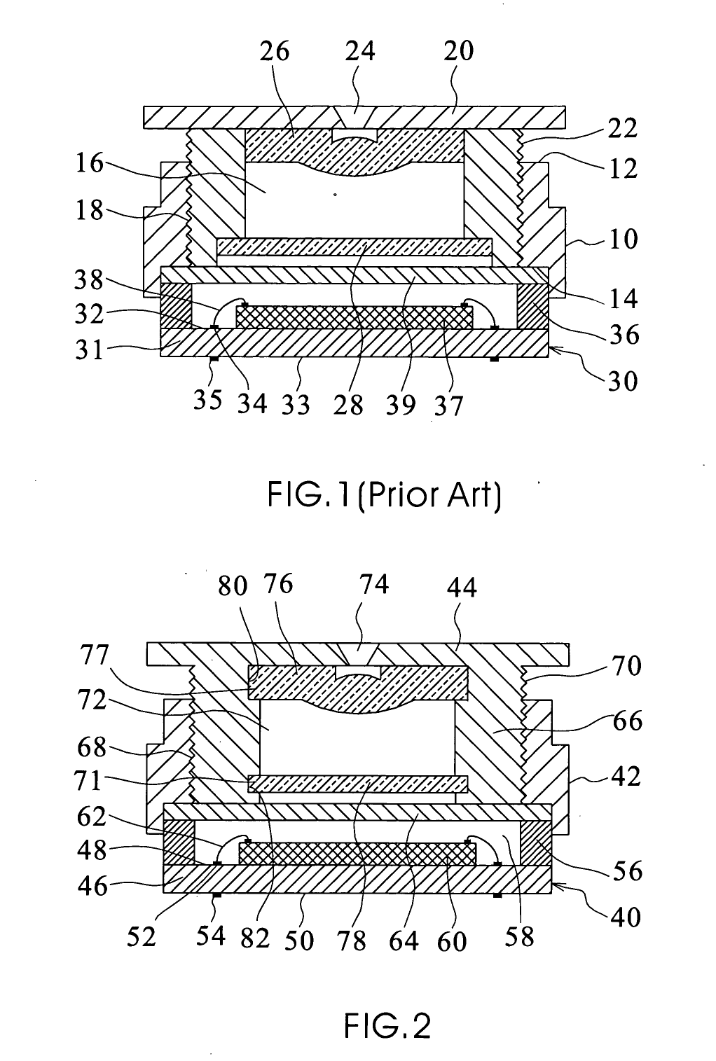

### DETAILED DESCRIPTION OF THE INVENTION

Referring to FIG. 2, an image sensor module of the invention includes an image sensor package 40, a lens holder 42, and a lens barrel 44.

The image sensor package 40 includes a substrate 46, a frame layer 56, a photosensitive chip 60, a transparent layer 64. The substrate 46 is formed with a top end face 48 on which first connected points 52 are formed, and a bottom end face 50 on which second connected points 54 are formed. The frame layer 56 is arranged on the top end face 48 of the substrate 46. A chamber 58 is defined between the substrate 46 and the frame layer 56. The photosensitive chip 60 is arranged within the chamber 58, and electrically connected the first connected points 52 by wires 62. The transparent layer 64 is a piece of glass, which is adhered on the frame layer 56 for encapsulating the photosensitive chip 60 and wires 62.

The lens holder 42 is formed with a chamber 66, which has an internal thread 68 formed at the inner wall of the chamber 66, so that the transparent layer 64 of the image sensor package 40 is arranged at the lens holder 42.

The lens barrel 44 is inserted within the chamber 66 of the lens holder 42, and is formed with an external thread 70, which is screwed on the internal thread 68 of the lens holder 42. The lens barrel is formed with an opening 72 and a hole 74 communicating the opening 72, which is formed with a first positioned slot 80 for positioning an aspheric lens 76 and a second positioned slot 82 under the first positioned slot 80 for positioning an infrared filter 78. The lens barrel 44, aspheric lens 76, and the infrared filter 78 are integrated formed by injecting molded.

A method for manufacturing the image sensor module of the present invention includes following steps of:
Providing an image sensor package 40 includes a substrate 46, a frame layer 56, a photosensitive chip 60, a transparent layer 64. The substrate 46 is formed with a top end face 48 on which first connected points 52 are formed, and a bottom end face 50 on which second connected points 54 are formed. The frame layer 56 is arranged on the top end face 48 of the substrate 46. A chamber 58 is defined between the substrate 46 and the frame layer 56. The photosensitive chip 60 is arranged within the chamber 58, and electrically connected the first connected points 52 by wires 62. The transparent layer 64 is a piece of glass, which is adhered on the frame layer 56 for encapsulating the photosensitive chip 60 and wires 62.
Providing a lens holder 42 is formed with a chamber 66, which has an internal thread 68 formed at the inner wall of the chamber 66, so that the transparent layer 64 of the image sensor package 40 is arranged at the lens holder 42.
Providing a lens barrel 44 is inserted within the chamber 66 of the lens holder 42, and is formed with an external thread 70, which is screwed on the internal thread 68 of the lens holder 42. The lens barrel is formed with an opening 72 and a hole 74 communicating the opening 72, which is formed with a first positioned slot 80 for positioning an aspheric lens 76 and a second positioned slot 82 under the first positioned slot 80 for positioning an infrared filter 78. The lens barrel 44, aspheric lens 76, and the infrared filter 78 are integrated formed by injecting molded

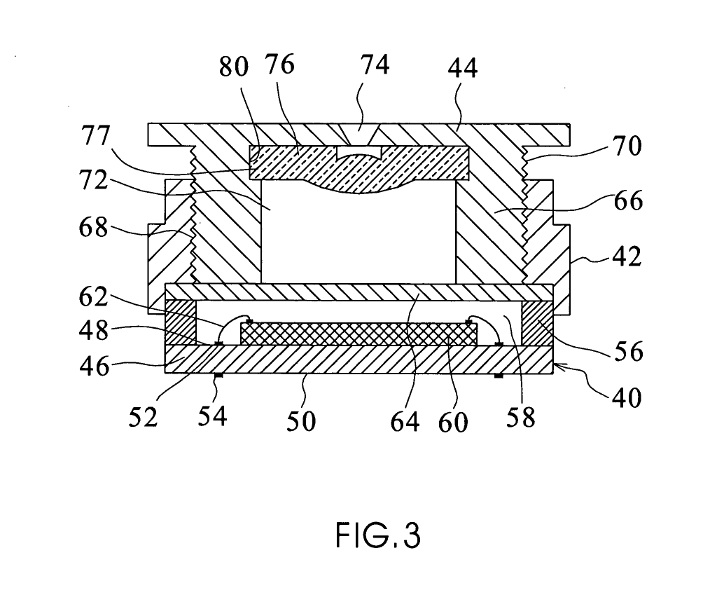

Please referring to FIG. 3, is a second schematic illustration showing the image sensor module of the invention. Wherein the transparent layer 64 of the image sensor package 40 is an infrared filter 78. Still the infrared filter 78 of the lens barrel 44 may be omitted.

The image sensor module of the invention, in which the lens barrel 44, the aspheric lens 76, and the infrared filter 78 are integrated formed by injecting molded, has the following advantages.
1. Still the image sensor module is capable of precisely positioning so as to facilitate the manufacturing processes.

While the invention has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

1. An image sensor module, comprising:
an image sensor package formed with a top end face having a transparent layer and a bottom end face;
a lens holder formed with a chamber, which has an internal thread formed at the inner wall, so that the transparent layer of the image sensor package is arranged at the lens holder;
a lens barrel inserted within the chamber of the lens holder, and formed with an external thread, which is screwed on the internal thread of the lens holder, the lens barrel being formed with an opening and a hole communicating the opening, which is formed with a first positioned slot for positioning an aspheric lens.

2. The image sensor module according to claim 1, wherein the lens barrel is formed with a second positioned slot under the first positioned slot for positioning an infrared filter.

3. The image sensor module according to claim 1, wherein the image sensor package includes a substrate, a frame arranged on the substrate, a photosensitive chip arranged on the substrate and electrically connected to the substrate by wires, and a transparent layer mounted on the frame layer.

4. The image sensor module according to claim 1, wherein the transparent layer is an infrared filter.

5. A method for manufacturing an image sensor module, comprising the steps of:
providing an image sensor package formed with a top end face having a transparent layer and a bottom end face;
providing a lens holder formed with a chamber, which has an internal thread formed at the inner wall, so that the transparent layer of the image sensor package is arranged at the lens holder;
providing a lens barrel inserted within the chamber of the lens holder, and formed with an external thread, which is screwed on the internal thread of the lens holder, the lens barrel being formed with an opening and a hole communicating the opening, which is formed with a first positioned slot for positioning an aspheric lens, the lens barrel and the aspheric being integrated formed by injecting molded.

7. The method according to claim 6, wherein lens barrel is formed with a second positioned slot under the first positioned slot for positioning an infrared filter.

8. The method according to claim 6, wherein the image sensor package includes a substrate, a frame arranged on the substrate, a photosensitive chip arranged on the substrate and electrically connected to the substrate by wires, and a transparent layer mounted on the frame layer.
